(19) United States
(12) Patent Application Publication
(10) Pub. No.: US 2007/0108111 A1
(43) Pub. Date: May 17, 2007

(54) Aquarium which air cleaning function by microorganism is added

(76) Inventor: Ki-Hae Yang, Jeollabuk-Do (KR)

Correspondence Address: John W. Renner, Esq.;Renner, Otto, Boiselle & Sklar LLP, 1621 Euclide Avenue, 19th Floor, Cleveland, OH, 44115, US

(21) Appl. No.: 11/647,662

(22) Filed: Dec. 29, 2006

(30) Foreign Application Priority Data
Jul. 1, 2004 (KR) 10-2004-0052803

(51) Int. Cl. A01K 63/04

(52) U.S. Cl. 210/167.21

(57) ABSTRACT

This device forcibly pumps exterior air into interior of sealed aquarium tank, installed influx fan (1) and outfall (2), through influx fan (1) consecutively providing aerobic microorganism with high concentration of oxygen for its metabolism which led to high efficiency of water treatment of the tank by aerobic microorganism and also treated pollutants by microorganism on media with forcibly pumped exterior air are emitted through outfall (2) while purifying indoor air through media.

### TECHNICAL FIELD

This invention is about purifying pollutants in the air or in indoors with microorganism which flows polluted air into cleaning device of aquarium with function of purifying contained water using microorganism and the pollutants are degraded and removed by metabolism of microorganism.

### BACKGROUND ART

There are three types of purifying polluted air; mechanical filter which collects pollutants with glass fiber or moltprene deodorization filter using active carbon and filter with many function using glass fiber and cellulose to collect fine grains which of them conforming to physical purification.

However, in this invention, biochemical degrading method by microorganism is used as well as physical method. Purifying technology which biochemically purifies pollutants with microorganism is generally used for waste water treatment. Especially, this technique is to make use of aquarium purification device which cleans contaminated water in aquarium with EM, Effective Microorganisms. And this is about an aquarium which has air cleaning function by added microorganism cleans polluted air indoors while purifying the pollutants using purification device which does not require of water in aquarium to be changed for certain period of time. At this time there are main EM, Effective Microorganisms observed such as Aspidisca costata, Actinophrys sol, Arcella vulgaris, Chaetospira muelleri and etc.,

This technology is about an aquarium with air cleaning function which pollutants in the air or indoors using aquarium purification device and also, while existing air purifying devices were limited to use physical purification method, this one biochemically degrades and removes pollutants with EM. Also, it is designed to purifies air pollutants as well as water in aquarium within purifier using ‘Aquarium purifier of no need to change water in the aquarium’ by the use of ‘Waste water and sewage treatment by instal ledtrickling filter (Utility Model Patent no.0305124) among purifying techniques with aerobic microorganism.

### DISCLOSURE

Technical Problem

One of the basic techniques which makes use of microorganism to get rid of organic matters when doing waster water and sewage treatment is “Activated sludge technique” and this technique has marked characteristic of culturing microorganism in waster water. At this time, microorganisms, effective to remove pollutants, are mostly aerobic microorganisms (metabolize using oxygen) and keeping high rate of aerobic organisms are difficult only with existing dissolved oxygen in waster water which necessarily requires to be artificially supplied with oxygen.

However, even artificial supply of oxygen is made, concentration of oxygen in waste water is normally maintained between 2˜4 ppm for economic reasons and technical problems. Under the condition of 2˜4 ppm of oxygen concentration, there is a limitation of aerobic microorganism's metabolism and also, problems of technology and operating system for constant maintenance of making optimum condition could become big variables.

Technical Solution

This aquarium purifying device is designed for microorganisms to directly make use of high concentration of oxygen in the air while maintaining stable metabolism without peripheral facility or technique. Purifying device installed the upper part of aquarium has microorganism media to maintain many numbers of aerobic or facultative microorganisms which is installed off the water not inside of it, aerobic or facultative microorganisms, inhabited in media exposed to air , could directly use oxygen which led to active metabolism of microbes to degrade and remove various organic matters effectively in water in the aquarium.

Advantageous Effects

This invention leads microorganism to contact pollutants with artificially supplying polluted air indoors or in the air through inflow fan (1). On the surface of media (3), with heighten humidity of aquarium tank trickled by pump, pollutants in the air is fixed by inertial collision and physical absorption.

There are two ways of pollutants in the air attached to purifying device, one is through absorption and inertial collision on the surface of media (3) and the other is through being dissolved in water of aquarium tank which is sprinkled to the surface of media. Also, it is designed that absorbed impurities on the wide surface of media (3) are degraded and removed by variety of effective microorganisms (EM) as sources of energy for their metabolism and other dissolved pollutants in water are consecutively sprinkled (6) on the surface of media (3) through pump (4) and pipe (5) of aquarium tank to be degraded and removed as a source of energy for various microorganisms. At this time, when turning water flow of the form of water in aquarium tank sprinkled to media and water flow run down after contacting surface of media into artificial falls, there is a merit of producing several different functions such as aquarium tank, air purifier and artificial falls through one system.

Purification efficiency of air pollutants by this work, is increased when the larger surface area of media becomes and the higher rates of contacting media to polluted air becomes.

Gas Removal Test (Gas Removal Test with Carbon Dioxide Analyzer)

Using ZRF CO Analyzer (FUZI made in Japan) add test sample of “Aquarium with air cleaning function by added microorganism” into sealed test container at the size of (1100 mm×1100mm×1800mm) and then install active carbon filter at the entrance of the test sample and after that, pump harmful matter, carbon monoxide, into it. And then after adjusting the initial concentration of inside of test device to reach about 50 vol ppm and connect to power supply for measuring the concentration of it with carbon monoxide measure by the time of half an hour, one, two, four and six hours (interior temperature: 26±5%, relative humidity: 30±5%) The results are as follows of table no. 1.

TABLE 1
TEST RESULT FOR GAS REMOVAL OF MONOXIDE(CO)

| | | | VALUE OF RESULT | |
|---|---|---|---|---|
| TEST ITEM | TIME | UNIT | BLK | TEST SAMPLE |
| GAS REMOVAL | 0 hr | vol ppm | 50 | 50 |
| TEST OF | 0.5 hr | | 50 | 50 |
| MONOXIDE(CO) | 1.0 hr | | 50 | 50 |
| | 2.0 hr | | 48 | 48 |
| | 4.0 hr | | 45 | 46 |
| | 6.0 hr | | 44 | 44 |

2. Gas Removal Test (Gas Removal Test by Gastek)

Using detector tube (GASTEK made in Japan), add test sample of “Aquarium with air cleaning function by added microorganism” into sealed test container at the size of (1100 mm×1100 mm×1800 mm) and then shut the container, after that, pump harmful matter, formaldehyde, into it. And then after adjusting the initial concentration of inside of test device to reach about 20 vol ppm and connect to power supply for measuring the concentration of formaldehyde by the time of half an hour, one, two, four and six hours with the detector tube. (interior temperature: 26±5° C., relative humidity: 30±5%) The results are as follows of table no. 2.

TABLE 2
GAS REMOVAL TEST RESULT OF FORMALDEHYDE(HCHO)

| | | | VALUE OF RESULT | |
|---|---|---|---|---|
| TEST ITEM | TIME | UNIT | BLK | TEST SAMPLE |
| GAS REMOVAL | 0 hr | vol | 20 | 20 |
| TEST OF | 0.5 hr | ppm | 20 | 13 |
| FORMALDEHYDE(HCHO) | 1.0 hr | | 18 | 8 |
| | 2.0 hr | | 18 | 4 |
| | 4.0 hr | | 16 | 3 |
| | 6.0 hr | | 16 | 2 |

3. Gas Removal Test (Gas Removal Test by Gastek)

Using PhoCheck 5000 (ION SCIENCE LTD. made in U.K), add test sample of “Aquarium with air cleaning function by added microorganism” into sealed test container at the size of (1100 mm×1100 mm×1800 mm) and then install active carbon filter at the entrance of the test sample and after that, pump harmful matter, benzene gas, into it. And then after adjusting the initial concentration of inside of test device to reach about 1 vol ppm and connect to power supply for measuring the concentration of it by the time of half an hour, one, two, four and six hours. (interior temperature: 26±5° C., relative humidity: 30±5%) The results are as follows of table no. 3.

TABLE 3
GAS REMOVAL TEST RESULT OF BENZENE(C₆H₆)

| | | | VALUE OF RESULT | |
|---|---|---|---|---|
| TEST ITEM | TIME | UNIT | BLK | TEST SAMPLE |
| GAS REMOVAL | 0 hr | vol ppm | 1.0 | 1.0 |
| TEST OF | 0.5 hr | | 0.9 | 0.9 |
| BENZENE(C₆H₆) | 1.0 hr | | 0.9 | 0.8 |
| | 2.0 hr | | 0.8 | 0.7 |
| | 4.0 hr | | 0.8 | 0.7 |
| | 6.0 hr | | 0.7 | 0.5 |

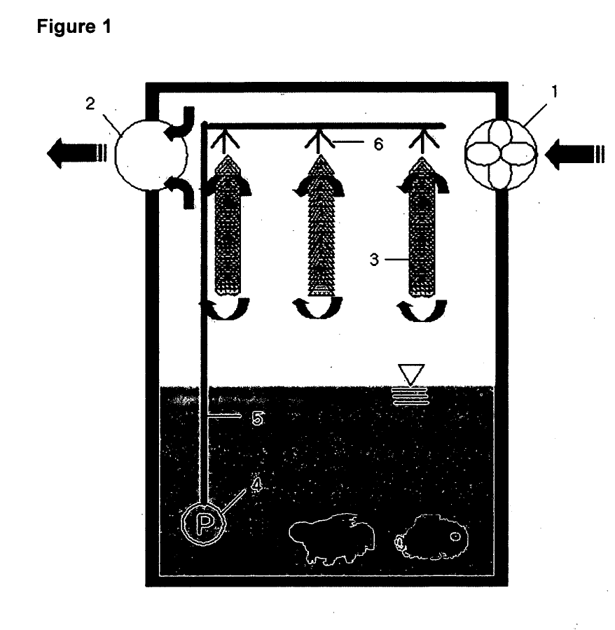

### DESCRIPTION OF DRAWINGS FIG. 1: INFLUX FAN, FIG. 2: OUTFALL, FIG. 3: MICROORGANISM MEDIA, FIG. 4: PUMP, FIG. 5: TRANSPORT PIPE, FIG. 6: SPRINKLE PIPE

### BEST MODE

This invention is composed of six procedures of influx fan (1), outfall (2), microorganism media (3), pump (4), transport pipe (5) and sprinkle pipe (6). Lead contacts between pollutants and microorganisms with supplying polluted air in the air or indoor artificially through influx fan. On the surface of media (3), with heighten humidity of aquarium tank sprinkled by pump, pollutants in the air is fixed by inertial collision and physical absorption. There are two ways of pollutants in the air attached to purifying device, one is through absorption and inertial collision on the surface of media (3) and the other is through being dissolved in water of aquarium tank which is sprinkled to the surface of media. Also, it is designed that absorbed impurities on the wide surface of media (3) are degraded and removed by variety of effective microorganisms (EM) as sources of energy for their metabolism and other dissolved pollutants in water are consecutively sprinkled (6) on the surface of media (3) through pump (4) and pipe (5) of aquarium tank to be degraded and removed as a source of energy for various microorganisms. This device forcibly pumps exterior air into interior of sealed aquarium tank, installed influx fan (1) and outfall (2), through influx fan (1) consecutively providing aerobic microorganism with high concentration of oxygen for its metabolism which led to high efficiency of water treatment of the tank by aerobic microorganism and also treated pollutants by microorganism on media with forcibly pumped exterior air are emitted through outfall (2) while purifying air indoors which serves double purposes.

### MODE FOR INVENTION

Media used for purifying device is a form of long line drooped 4 cm below of 0.1 mm and less of thread and for air contacting media is not limited to different forms such as triangle or rope shapes as long as it can hung on to, also materials for media are vary from polyethylene (PE) and polypropylene (PP) of superior durability through activated carbon, synthetic zeolite and ceramic of various and different forms of materials.

Particularly, ceramic made under high temperature is used for different types of water purifiers and when the ceramic is used with purification device by the invention, it will purify pollutants as well as promoting growth and metabolism of microorganism. Aerobic and facultative organisms inhabited under the condition of maintaining high concentration of oxygen designed by various types of medias having different functions can actively cope with change of pollutant loads and so, even it is supplied with pollutants except organic matters into aquarium tank, the microorganisms can adjust themselves to the environment within short period of time to maintain stable metabolism degrading different harmful materials.

In other words, removal of impurities and pollutants in the air as well as removing of organic matters inside of aquarium tank using microorganism under the optimum condition of habitation, is a remarkable feature of this invention.

### INDUSTRIAL APPLICABILITY

As it is described, main purpose of the invention is for purifying polluted air with aquarium purification device. Artificial influx of exterior air into purification device becomes means of constant supply of high concentration of oxygen to aerobic microorganism (EM) to degrade and remove impurities under the environment of smooth supply of oxygen. Furthermore, it can achieve air purification effectiveness which of the principle is inflow of exterior air is fixed on water in the aquarium tank by inertial collision, physical absorption and dissolving and then biochemically degraded and removed by microorganisms.

The air after removal of pollutants in the air or indoor maintains relatively high concentration of oxygen refreshing surroundings which means, water of the aquarium tank designed according to this invention has wide surface area leading to large amount of water vaporized through contacting air supplying constant and active humidity of the indoor air functioning as a humidifier.

In modern society, there are many diseases such as respiratory diseases, skin ailments and others caused by VOCs or offensive odor, this newly invented purification device effectively removes pollutants and impurities as well as adjusting interior humidity creating hygienic living environment for physical health condition and it also comes into formation of aquarium tank, interior waterfalls and etc., as offering aesthetic beauty for the sake of modern people's health.

1. This aquarium purifying device has a remarkable function of wastewater treatment leads to contacts of between pollutants and microorganism with artificial inflow of polluted air in the air or indoor containing influx fan when treating and emitting absorbed exterior air by biofilm exposed to air among indoor air purification devices.

2. Air purifying aquarium with biofilm has function of water purifying feature for aquarium tank of using nozzle biofilm exposed to air in “claim No. 1”

3. An aquarium having a function of purifying air, the aquarium comprising:
an air purifying device that absorbs external air to treat the external air by using a bio-film exposed to an atmosphere, wherein the air purifying device includes a blower which forcibly absorbs polluted air from the atmosphere or an indoor space to lead a contact between pollutants and microorganism, thereby treating the pollutants.

4. The aquarium as claimed in claim 3, wherein the bio-film exposed to the atmosphere is used for purifying water contained in an aquarium tank.
